(19) United States
(12) Patent Application Publication
(10) Pub. No.: US 2008/0262829 A1
(43) Pub. Date: Oct. 23, 2008

(54) METHOD AND APPARATUS FOR GENERATING A TRANSLATION AND MACHINE TRANSLATION

(75) Inventors: Zhanyi Liu, Beijing (CN); Haifeng Wang, Beijing (CN); Hua Wu, Beijing (CN)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/036,568

(22) Filed: Feb. 25, 2008

(30) Foreign Application Priority Data
Mar. 21, 2007 (CN) 200710089195.1

(51) Int. Cl. G06F 17/28

(52) U.S. Cl. 704/4

(57) ABSTRACT

The present invention provides a method and an apparatus for generating a translation and machine translation. According to an aspect of the present invention, there is provided a method for generating a translation, wherein a sentence of a first language to be translated is split into a plurality of fragments, an aligned bilingual example corpus comprises a plurality of example sentence pairs of the first language and a second language and alignment information between each sentence pair, and comprises at least one translation fragment of the second language corresponding to each of said plurality of fragments of the first language; the method comprising: selecting an optimum translation fragment combination of the second language from a plurality of possible translation fragment combinations of the second language corresponding to said sentence of the first language based on an integrated score obtained from a plurality of feature functions on a translation fragment combination; and generating the translation of the second language based on said optimum translation fragment combination.

### CROSS-REFERENCE TO RELATED APPLICATION

This application is based upon and claims the benefit of priority from prior Chinese Patent Application No. 200710089195.1, filed on Mar. 21, 2007; the entire contents of which are incorporated herein by reference.

### TECHNICAL FIELD

The present invention relates to technology of information processing, more particularly to technology of translation generation and technology of machine translation based on bilingual alignment technology.

### TECHNICAL BACKGROUND

Example-Based Machine Translation (EBMT) system is an automatic translation system, and the translation system directly uses aligned bilingual example sentences as translation knowledge. For an inputted sentence to be translated, the translation system first retrieves a matched bilingual example sentence in an aligned bilingual example corpus by using a matching technology, and then extracts a translation fragment corresponding to a matched fragment from the bilingual example sentence by using alignment information of the bilingual example sentence. Finally, the translation system combines these translation fragments into a translation of the inputted sentence.

In the current EBMT systems, there are two main approaches for the translation generation:

(1) Semantic Approach

This approach obtains an appropriate target language fragment for each part of the input sentence by the use of thesaurus. Then the translation is generated by the recombination of the target language fragments in a pre-defined order.

(2) Statistical Approach

This approach generates the translation by recombining target language fragments with a statistical language model.

The first approach does not take into account the transition between target language fragments. Therefore, the fluency of this kind of translation is poor.

The second approach can solve the fluency problem by using the n-gram co-occurrence statistics. However, this method does not take into account the semantic relations between the example and the input sentence. As a result, the accuracy of this kind of translation is weak.

Therefore, there is a need to provide a method for generating a translation and machine translation considering the above-mentioned factors simultaneously.

### SUMMARY OF THE INVENTION

In order to solve the above-mentioned problems in the prior technology, the present invention provides a method and an apparatus for generating a translation and machine translation.

According to an aspect of the present invention, there is provided a method for generating a translation, wherein a sentence of a first language to be translated is split into a plurality of fragments, an aligned bilingual example corpus comprises a plurality of example sentence pairs of the first language and a second language and alignment information between each sentence pair, and comprises at least one translation fragment of the second language corresponding to each of the above-mentioned plurality of fragments of the first language; the method comprising: selecting an optimum translation fragment combination of the second language from a plurality of possible translation fragment combinations of the second language corresponding to the sentence of the first language based on an integrated score obtained from a plurality of feature functions on a translation fragment combination; and generating the translation of the second language based on the above-mentioned optimum translation fragment combination.

According to another aspect of the present invention, there is provided a method for generating a translation, wherein an aligned bilingual example corpus comprises a plurality of example sentence pairs of a first language and a second language and alignment information between each sentence pair, a sentence of the first language to be translated is matched with respect to the above-mentioned aligned bilingual example corpus, and at least one translation fragment of the second language corresponding to each possible fragment of the above-mentioned sentence of the first language is obtained; the method comprising: selecting an optimum translation fragment combination of the second language by using a search algorithm, wherein an integrated score is obtained from a plurality of feature functions on a possible translation fragment or a combination of translation fragments as a cost of the above-mentioned search algorithm; and generating the translation of the second language based on the above-mentioned optimum translation fragment combination.

According to another aspect of the present invention, there is provided a method for machine translation, wherein an aligned bilingual example corpus comprises a plurality of example sentence pairs of a first language and a second language and alignment information between each sentence pair; the method comprising: splitting a sentence of the first language to be translated into a plurality of fragments; and generating the translation of the second language by means of the above-mentioned method for generating a translation.

According to another aspect of the present invention, there is provided a method for machine translation, wherein an aligned bilingual example corpus comprises a plurality of example sentence pairs of a first language and a second language and alignment information between each sentence pair; the method comprising: matching a sentence of the first language to be translated with respect to the above-mentioned aligned bilingual example corpus to obtain at least one translation fragment of the second language corresponding to each possible fragment of the above-mentioned sentence of the first language; and generating the translation of the second language by means of the above-mentioned method for generating a translation.

According to another aspect of the present invention, there is provided an apparatus for generating a translation, wherein a sentence of a first language to be translated is split into a plurality of fragments, an aligned bilingual example corpus comprises a plurality of example sentence pairs of the first language and a second language and alignment information between each sentence pair, and comprises at least one translation fragment of the second language corresponding to each of the above-mentioned plurality of fragments of the first language; the apparatus comprising: a selecting unit configured to select an optimum translation fragment combination of the second language from a plurality of possible translation fragment combinations of the second language corresponding to the above-mentioned sentence of the first language based on an integrated score obtained from a plurality of feature functions on a translation fragment combination; and a translation generating unit configured to generate the translation of the second language based on the above-mentioned optimum translation fragment combination.

According to another aspect of the present invention, there is provided an apparatus for generating a translation, wherein an aligned bilingual example corpus comprises a plurality of example sentence pairs of a first language and a second language and alignment information between each sentence pair, a sentence of the first language to be translated is matched with respect to the above-mentioned aligned bilingual example corpus, and at least one translation fragment of the second language corresponding to each possible fragment of the above-mentioned sentence of the first language is obtained; the apparatus comprising: a selecting unit configured to select an optimum translation fragment combination of the second language by using a search algorithm, wherein an integrated score is obtained from a plurality of feature functions on a possible translation fragment or a combination of translation fragments as a cost of the above-mentioned search algorithm; and a translation generating unit configured to generate the translation of the second language based on the above-mentioned optimum translation fragment combination.

According to another aspect of the present invention, there is provided an apparatus for machine translation, wherein an aligned bilingual example corpus comprises a plurality of example sentence pairs of a first language and a second language and alignment information between each sentence pair; the apparatus comprising: a splitting unit configured to split a sentence of the first language to be translated into a plurality of fragments; and the above-mentioned apparatus for generating a translation configured to generate the translation of the second language.

According to another aspect of the present invention, there is provided an apparatus for machine translation, wherein an aligned bilingual example corpus comprises a plurality of example sentence pairs of a first language and a second language and alignment information between each sentence pair; the apparatus comprising: a matching unit configured to match a sentence of the first language to be translated with respect to the above-mentioned aligned bilingual example corpus to obtain at least one translation fragment of the second language corresponding to each possible fragment of the above-mentioned sentence of the first language; and the above-mentioned apparatus for generating a translation configured to generate the translation of the second language.

### BRIEF DESCRIPTION OF THE DRAWINGS

FIG. 1 is a flowchart showing a method for generating a translation according to an embodiment of the present invention;

FIG. 2 is a sketch map showing an example of calculating an integrated score according to the embodiment of the present invention;

FIG. 3 is a sketch map showing an example of a search algorithm according to the embodiment of the present invention;

FIG. 4 is a flowchart showing a method for generating a translation according to another embodiment of the present invention;

FIG. 5 is a flowchart showing a method for machine translation according to another embodiment of the present invention;

FIG. 6 is a flowchart showing a method for machine translation according to another embodiment of the present invention;

FIG. 7 is a block diagram showing an apparatus for generating a translation according to another embodiment of the present invention;

FIG. 8 is a block diagram showing an apparatus for generating a translation according to another embodiment of the present invention;

FIG. 9 is a block diagram showing an apparatus for machine translation according to another embodiment of the present invention; and

FIG. 10 is a block diagram showing an apparatus for machine translation according to another embodiment of the present invention.

### DETAILED DESCRIPTION OF THE INVENTION

Next, a detailed description of each embodiment of the present invention will be given in conjunction with the accompany drawings.

Method for Generating a Translation

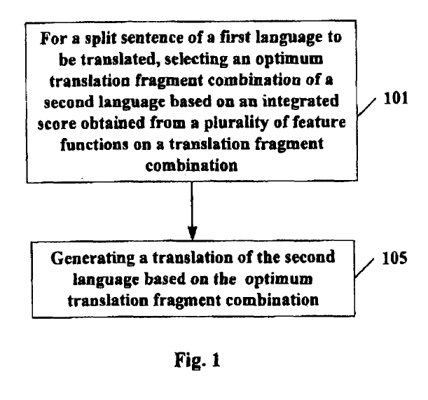

FIG. 1 is a flowchart showing a method for generating a translation according to an embodiment of the present invention. As shown in FIG. 1, first at Step 101, for a split sentence of a first language to be translated, an optimum translation fragment combination of a second language is selected based on an integrated score obtained from a plurality of feature functions on a translation fragment combination.

Specifically, in this embodiment, the sentence of the first language to be translated is split into a plurality of fragments by hand or automatically, and one or a plurality of translation fragments of the second language corresponding to each of the plurality of fragments of the first language to be translated are searched in an aligned bilingual example corpus by matching. The aligned bilingual example corpus is a bilingual example corpus word-aligned by a professional (for example, a translator) by hand or by a computer automatically, which comprises a plurality of example sentence pairs of the first language and the second language and alignment information between each sentence pair. It should be understood that, the present invention has no special limitation to the method for splitting a sentence of the first language to be translated, and any method as known in the art can be used, if only a sentence to be translated can be split into effective fragments, translation fragments of which can be found in an aligned bilingual example corpus.

Next, a detailed description of the plurality of feature functions and a calculating process of the integrated score obtained from a plurality of feature functions on a translation fragment combination will be given.

In this embodiment, the above-mentioned feature functions indicate a plurality of kinds of translation knowledge contained in a translation generating model of a machine translation system based on bilingual example sentences (in the model, translation knowledge is called a feature function), for example, a feature function of calculating similarity between a bilingual example sentence and an inputted sentence, reliability of a bilingual example sentence and fluency of a generated translation.

The feature functions of the embodiment comprise but not limit to the following kinds:

A a translation probability of a word from a source language to a target language

$${h}_{w , f -> e} ( e , f ) = {\prod }_{i}^{ } p ( {e}_{{a}_{i}} \vert {f}_{i} )$$

B a translation probability of a word from a target language to a source language

$${h}_{w , e -> f} ( e , f ) = {\prod }_{i}^{ } p ( {f}_{{a}_{i}} \vert {e}_{i} )$$

C a translation probability of a phrase from a source language to a target language

$${h}_{p h , f -> e} ( e , f ) = {\prod }_{i}^{ } p ( {e}_{{a}_{i}}^{′} \vert {f}_{i}^{′} )$$

D a translation probability of a phrase from a target language to a source language

$${h}_{p h , e -> f} ( e , f ) = {\prod }_{i}^{ } p ( {f}_{{a}_{i}}^{′} \vert {e}_{i}^{′} )$$

E a selection probability of a target language based on length

h_{TLS}(e,f,E)=h_{TLS}(e,f)=log p(I|J)

With respect to a sentence to be translated, this function will give a smaller value for a shorter or a longer translation.

F a target language model

$${h}_{TLM} ( e , f , E ) = {h}_{TLM} ( e ) = log {\prod }_{i = 1 … I}^{ } p ( {e}_{i} \vert {e}_{i - 2} , {e}_{i - 1} )$$

The bigger the value of this feature function is, the better the fluency of the translation generated is.

G a semantic similarity

$${h}_{SS} ( e , f , E ) = {h}_{SS} ( f , E ) = log {\prod }_{z ∈ E}^{ } M ( z , f )$$

The bigger the value of this feature function is, the closer the meaning between corresponding fragments in a bilingual example sentence and an inputted sentence is.

In the above-mentioned plurality of feature functions:

h denotes a feature;

f denotes a sentence to be translated;

e denotes a translation generated;

eᵢ denotes a word of a translation;

fᵢ denotes a word of an inputted sentence;

e′ᵢ denotes a phrase of a translation;

fᵢ denotes a phrase of an inputted sentence;

aᵢ denotes a unit number aligning with the i^{th} unit;

I denotes length of e;

J denotes length of f; and

M(z,f) denotes semantic similarity between corresponding fragments in a bilingual example sentence and an inputted sentence.

Specifically, the feature functions A, B and E are seen in a doctor's dissertation published in 2003 “Noun Phrase Translation, University of Southern California”, Philipp Koehn, which is incorporated herein by reference (hereinafter reference 1).

The feature functions C and D are seen in an article published in 2002 “Discriminative training and maximum entropy models for statistical machine translation”, Franz Josef Och and Hermann Ney, in Proceedings of the 40th Annual Meeting of the ACL, pages 295-302, which is incorporated herein by reference (hereinafter reference 2).

The feature function F is seen in an article published in 2002 “SRILM—an extensible language modeling toolkit”, Andreas Stolcke, in Proceedings of the International Conference on Spoken Language Processing, volume 2, pages 901-904, which is incorporated herein by reference (hereinafter reference 3).

The feature function G is seen in a published article “Example-based machine translation based on TSC and statistical generation”, Liu Zhanyi, Wang Haifeng and Wu Hua, MT Summit X, Phuket, Thailand, Sep. 13-15, 2005, which is incorporated herein by reference (hereinafter reference 4).

In this embodiment, the above-mentioned feature functions A-G are shown, however, it should be understood that, the present invention has no special limitation to this, and any feature function contributing to generating a translation can be comprised.

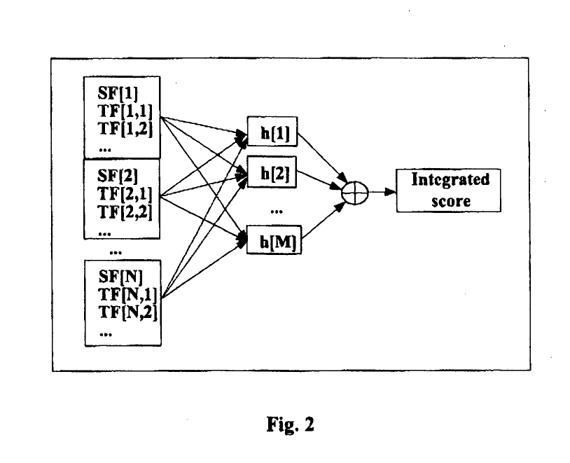

Next, a detailed description of a calculating process of an integrated score obtained from the above-mentioned plurality of feature functions on a translation fragment combination will be given in conjunction with FIG. 2.

FIG. 2 is a sketch map showing an example of calculating an integrated score according to the embodiment of the present invention. In FIG. 2, first, the sentence of the first language to be translated is split into N fragments, wherein SF[i] denotes the i^{th} fragment of the sentence to be translated. Next, one or a plurality of translation fragments are selected in the aligned bilingual example corpus with respect to each fragment of the sentence to be translated, wherein TF[i,j] denotes the j^{th} translation fragment corresponding to the i^{th} fragment of the sentence to be translated. Next, these selected translation fragments are evaluated respectively by using M feature functions, wherein h[m] denotes the m^{th} feature function on the translation fragment. Then, an integrated score is calculated by using a log-linear model based on the following formula (I):

$$s ( e ) = {\sum }_{m = 1}^{M} {λ}_{m} {h}_{m} ( e , f , E ) \qquad ( 1 )$$

wherein hₘ denotes the m^{th} feature function, λₘ denotes the weight of the m^{th} feature function, f denotes the sentence of the first language to be translated, e denotes the translation fragment combination of the second language, E denotes a collection of translation fragments required to generate e, and s(e) denotes the integrated score obtained from the plurality of feature functions on e.

In this embodiment, the weight of each feature function is taken into account preferably, wherein a training method of a weight of a feature function is seen in an article published in 2003 “Minimum error rate training in statistical machine translation”, Franz Josef Och., in proceedings of the 41st Annual Meeting of the ACL, pages 160-167, which is incorporated herein by reference (hereinafter reference 5). However, it should be understood that, the above-mentioned integrated score can be calculated directly by integrating scores obtained from each feature function on the translation fragment combination with a log-linear model without taking into account the weight of each feature function.

At Step 101, the integrated score of each of all translation fragment combinations can be calculated with the above-mentioned plurality of feature functions by using the above-mentioned method shown in FIG. 2, thereby, a translation fragment combination with a highest score is selected as an optimum translation fragment combination of the second language.

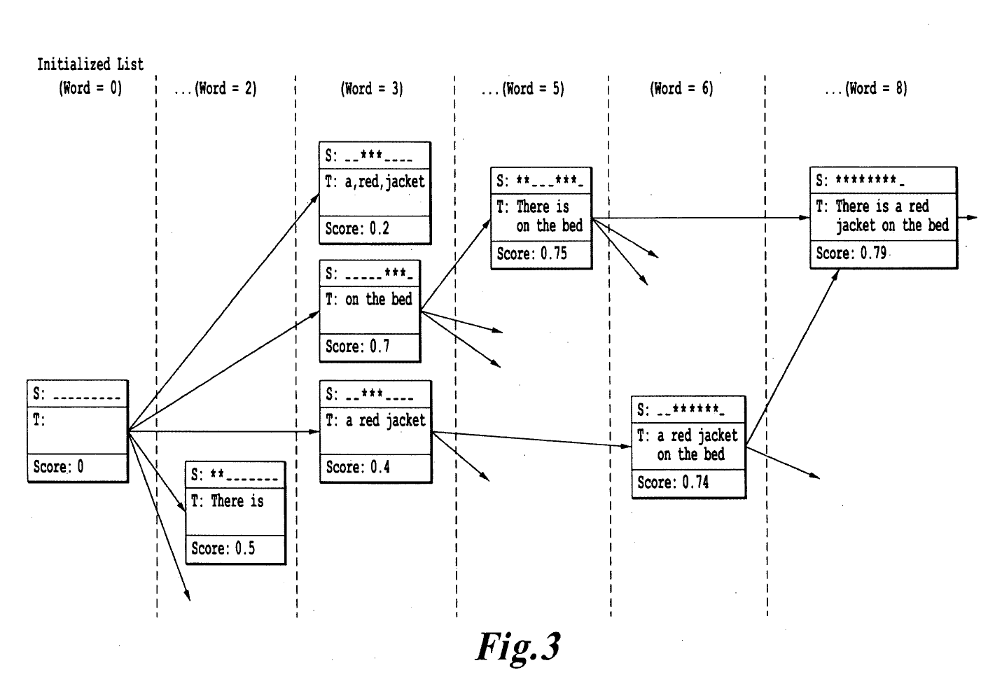

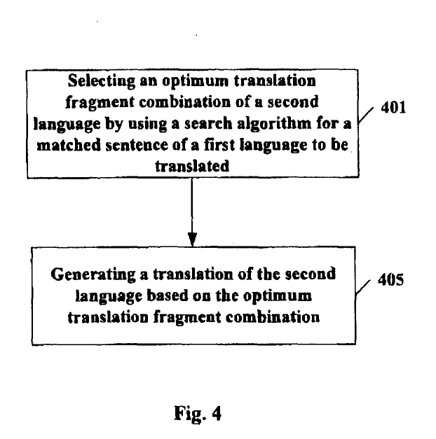

Optionally, in this embodiment, an optimum translation fragment combination of the second language also can be selected from a plurality of translation fragment combinations of the second language corresponding to the sentence of the first language by using a search algorithm. In this embodiment, the search algorithm comprises any algorithm as known in the art, for example, Beam search algorithm, A search algorithm and A* search algorithm etc, and the present invention has no special limitation to this. A detailed description of a detailed process of a search algorithm will be given in the embodiment of FIG. 4 in conjunction with FIG. 3, wherein the difference with the following embodiment is, in this embodiment, the sentence of the first language to be translated has been split into a plurality of fragments, and not all possible fragments of the sentence to be translated need to be performed with a search algorithm.

Optionally, in this embodiment, the sentence of the first language to be translated can be split in a plurality of splitting schemes, for example, the sentence to be translated is split automatically by a splitting algorithm based on all sentence fragments found. For example:

A sentence to be translated=“w1 w2 w3 w4 w5 w6 w7 w8 w9”

The effective fragments comprise:

F1=w1 w2 w3

F2=w4 w5 w6

F3=w7 w8 w9

F4=w1 w2 w3 w4

F5=w5 w6 w7 w8 w9

The above fragments can compose two splitting schemes “f1 f2 f3” or “f4 f5”.

For the first splitting scheme “f1 f2 f3”, an optimum translation fragment combination of the second language is selected by using the above-mentioned method described at Step 101, wherein integrated scores of all translation fragment combinations of the splitting scheme “f1 f2 f3” are calculated with the above-mentioned plurality of feature functions by using the above-mentioned method shown in FIG. 2, thereby, a translation fragment combination with a highest score is selected as the optimum translation fragment combination of the second language, or the optimum translation fragment combination of the second language also can be selected from a plurality of translation fragment combinations of the second language corresponding to the sentence of the first language by using a search algorithm.

For the second splitting scheme “f4 f5”, an optimum translation fragment combination of the second language is selected by using the above-mentioned method described at Step 101, wherein integrated scores of all translation fragment combinations of the splitting scheme “f4 f5” are calculated with the above-mentioned plurality of feature functions by using the above-mentioned method shown in FIG. 2, thereby, a translation fragment combination with a highest score is selected as the optimum translation fragment combination of the second language, or the optimum translation fragment combination of the second language also can be selected from a plurality of translation fragment combinations of the second language corresponding to the sentence of the first language by using a search algorithm.

Then, the integrated scores of the optimum translation fragment combinations of the two splitting schemes are compared, the translation fragment combination with a high score is kept, and the translation fragment combination with a low score is eliminated, thereby, the optimum translation fragment combination of the second language is obtained for the sentence of the first language to be translated.

Further, the optimum translation fragment combination of the second language also can be selected from a plurality of translation fragment combinations of the second language corresponding to the sentence of the first language by using a search algorithm with respect to the first splitting scheme “f1 f2 f3” and the second splitting scheme “f4 f5”.

It should be understood that, although two splitting schemes are shown herein, the present invention does not limit to this, and it also can have more than two splitting schemes, wherein each splitting scheme merely needs to be calculated, and a plurality of splitting schemes are compared, and the optimum translation fragment combination of the second language is obtained finally.

At last, at Step 105, the translation of the second language is generated based on the above-mentioned optimum translation fragment combination.

By using the method for generating a translation of the embodiment, aligned bilingual example sentences are used as translation knowledge (feature functions namely), and the efficiency of generating a translation is provided effectively relative to the method for generating a translation based on regulations. At the same time, this method can generate a translation with a better quality in a special application.

Further, a translation generated is evaluated with a plurality of kinds of translation knowledge from different points of view by using the method for generating a translation of the embodiment, thus a translation with a high quality is obtained. For example, since translation knowledge used comprises semantic resources and a target language model, the fluency of a translation generated is favorable as well as the semantic similarity thereof with the inputted sentence is very high.

Further, the method for generating a translation of the embodiment can be extended by adding new translation knowledge, thereby the quality of the translation can be further improved.

Method for Generating a Translation

Under the same inventive conception, FIG. 4 is a flowchart showing a method for generating a translation according to another embodiment of the present invention. Next, the present embodiment will be described in conjunction with FIG. 4. For those same parts as the above embodiments, the description of which will be appropriately omitted.

As shown in FIG. 4, first, at Step 401, an optimum translation fragment combination of the second language is selected by using a search algorithm for a matched sentence of the first language to be translated.

Specifically, in this embodiment, one or a plurality of translation fragments of the second language corresponding to each possible fragment of the first language to be translated are searched in an aligned bilingual example corpus by matching. The aligned bilingual example corpus is a bilingual example corpus word-aligned by a professional (for example, a translator) by hand or by a computer automatically, which comprises a plurality of example sentence pairs of the first language and the second language and alignment information between each sentence pair. It should be understood that, the present invention has no special limitation to the method for matching a sentence of the first language to be translated, and any method as known in the art can be used, if only a corresponding translation fragment can be found for each possible fragment of the sentence to be translated in an aligned bilingual example corpus.

In this embodiment, the search algorithm comprises any algorithm as known in the art, for example, Beam search algorithm, A search algorithm and A* search algorithm etc, and the present invention has no special limitation to this. A detailed description of a detailed process of a search algorithm will be given in conjunction with FIG. 3. FIG. 3 is a sketch map showing an example of a search algorithm according to the embodiment of the present invention, wherein Beam search algorithm is given as an example to explain the process of a search algorithm briefly, and a detailed description is seen in an article published in 2004 “a beam search decoder for phrase-based statistical machine translation models”, Philipp Koehn and Pharaoh, in Proceedings of the Sixth Conference of the Association for Machine Translation in the Americas, pages 115-124, which is incorporated herein by reference (hereinafter reference 6), and an article published in 1998 “Statistical Methods for Speech Recognition”, Jelinek F., The MIT Press, which is incorporated herein by reference (hereinafter reference 7).

In the embodiment of FIG. 3, the sentence to be translated is hypothesized to have 9 words. A translation of each possible fragment is searched in the aligned bilingual example corpus. For example:

A sentence fragment: There is a red jacket on the bed

A translation fragment:

[symbol]

[symbol]

[symbol]

[symbol]

[symbol]

In FIG. 3, each status comprises:

S: a sign, if a word is translated, the word is signed with “*”, otherwise, if a word is not translated, the word is signed with “-”;

T: a translation of the word with “*”;

Score: an integrated score of the translation obtained.

Specifically, Beam search algorithm is performed as follows:

First, a list (words=0 . . . 9) is initialized;

Next, for s=0 to 9:

Extending each status in S[s]

A new status is stored in a corresponding list based on a status sign. If the amount of words translated in the status is x, the status will be stored in the list of words=x.

If there is a status same with the new status in the list, the two statuses are compared, and the status with a high score is kept.

Pruning the List

If the amount of the statuses in one list is bigger than a predetermined threshold, the statuses with small scores are pruned.

Finally, a translation fragment combination with a highest score is searched in the list S[9] as an optimum translation fragment combination of the second language selected for a sentence of the first language to be translated.

In the above-mentioned search algorithm, the integrated score obtained from a plurality of feature functions on each translation fragment or each fragment combination is calculated based on the method of the above-mentioned embodiment of FIG. 2, the description of which will be appropriately omitted.

At last, at Step 405, the translation of the second language is generated based on the above-mentioned optimum translation fragment combination.

By using the method for generating a translation of the embodiment, aligned bilingual example sentences are used as translation knowledge (feature functions namely), and the efficiency of generating a translation is provided effectively relative to the method for generating a translation based on regulations. At the same time, this method can generate a translation with a better quality in a special application.

Further, a translation generated is evaluated with a plurality of kinds of translation knowledge from different points of view by using the method for generating a translation of the embodiment, thus a translation with a high quality is obtained. For example, since translation knowledge used comprises semantic resources and a target language model, the fluency of a translation generated is favorable as well as the semantic similarity thereof with the inputted sentence is very high.

Further, the method for generating a translation of the embodiment can be extended by adding new translation knowledge, thereby the quality of the translation can be further improved.

Further, the method for generating a translation of the embodiment does not need to split a sentence of the first language to be translated in advance, and it merely needs to generate a translation with a high quality by using a search algorithm.

Method for Machine Translation

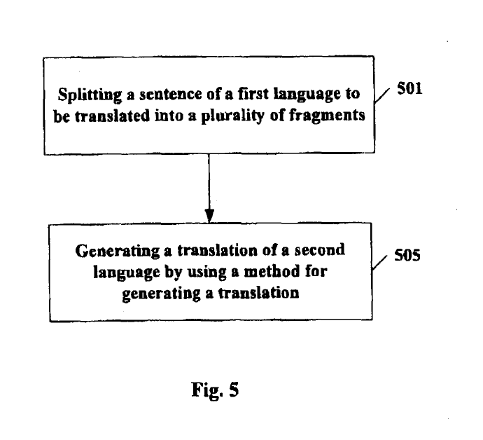

Under the same inventive conception, FIG. 5 is a flowchart showing a method for machine translation according to another embodiment of the present invention. Next, the present embodiment will be described in conjunction with FIG. 5. For those same parts as the above embodiments, the description of which will be appropriately omitted.

As shown in FIG. 5, first, at Step 501, a sentence of the first language to be translated is split into a plurality of fragments.

Specifically, in this embodiment, the sentence of the first language to be translated is split into a plurality of fragments by hand or automatically, and one or a plurality of translation fragments of the second language corresponding to each of the plurality of fragments of the first language to be translated are searched in an aligned bilingual example corpus by matching. The aligned bilingual example corpus is a bilingual example corpus word-aligned by a professional (for example, a translator) by hand or by a computer automatically, which comprises a plurality of example sentence pairs of the first language and the second language and alignment information between each sentence pair. It should be understood that, the present invention has no special limitation to the method for splitting a sentence of the first language to be translated, and any method as known in the art can be used, if only a sentence to be translated can be split into effective fragments, translation fragments of which can be found in an aligned bilingual example corpus.

Next, at Step 505, the translation of the second language is generated by means of the above-mentioned method for generating a translation of the embodiment of FIG. 1, and the detailed description is same with the above-mentioned embodiment, which will be omitted herein.

By using the method for machine translation of the embodiment, aligned bilingual example sentences are used as translation knowledge (feature functions namely), and the efficiency of machine translation is provided effectively relative to the method for machine translation based on regulations. At the same time, this method can generate a translation with a better quality in a special application.

Further, a translation generated is evaluated with a plurality of kinds of translation knowledge from different points of view by using the method for machine translation of the embodiment, thus a translation with a high quality is obtained. For example, since translation knowledge used comprises semantic resources and a target language model, the fluency of a translation generated is favorable as well as the semantic similarity thereof with the inputted sentence is very high.

Further, the method for machine translation of the embodiment can be extended by adding new translation knowledge, thereby the quality of the translation can be further improved.

Method for Machine Translation

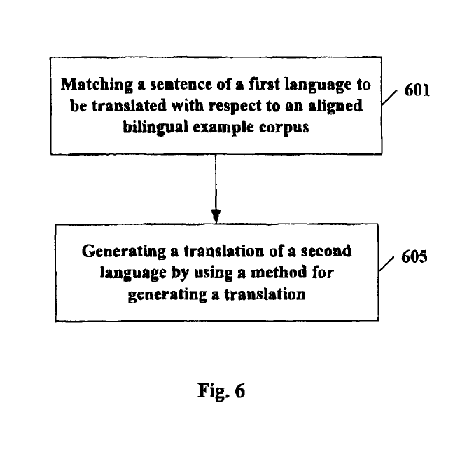

Under the same inventive conception, FIG. 6 is a flowchart showing a method for machine translation according to another embodiment of the present invention. Next, the present embodiment will be described in conjunction with FIG. 6. For those same parts as the above embodiments, the description of which will be appropriately omitted.

As shown in FIG. 6, first, at Step 601, a sentence of the first language to be translated is matched with respect to an aligned bilingual example corpus.

Specifically, in this embodiment, one or a plurality of translation fragments of the second language corresponding to each possible fragment of the first language to be translated are searched in an aligned bilingual example corpus by matching. The aligned bilingual example corpus is a bilingual example corpus word-aligned by a professional (for example, a translator) by hand or by a computer automatically, which comprises a plurality of example sentence pairs of the first language and the second language and alignment information between each sentence pair. It should be understood that, the present invention has no special limitation to the method for matching a sentence of the first language to be translated, and any method as known in the art can be used, if only a corresponding translation fragment can be found for each possible fragment of the sentence to be translated in an aligned bilingual example corpus.

Next, at Step 605, the translation of the second language is generated by means of the above-mentioned method for generating a translation of the embodiment of FIG. 4, and the detailed description is same with the above-mentioned embodiment, which will be omitted herein.

By using the method for machine translation of the embodiment, aligned bilingual example sentences are used as translation knowledge (feature functions namely), and the efficiency of machine translation is provided effectively relative to the method for machine translation based on regulations. At the same time, this method can generate a translation with a better quality in a special application.

Further, a translation generated is evaluated with a plurality of kinds of translation knowledge from different points of view by using the method for machine translation of the embodiment, thus a translation with a high quality is obtained. For example, since translation knowledge used comprises semantic resources and a target language model, the fluency of a translation generated is favorable as well as the semantic similarity thereof with the inputted sentence is very high.

Further, the method for machine translation of the embodiment can be extended by adding new translation knowledge, thereby the quality of the translation can be further improved.

Further, the method for machine translation of the embodiment does not need to split a sentence of the first language to be translated in advance, and it merely needs to generate a translation with a high quality by using a search algorithm.

Apparatus for Generating a Translation

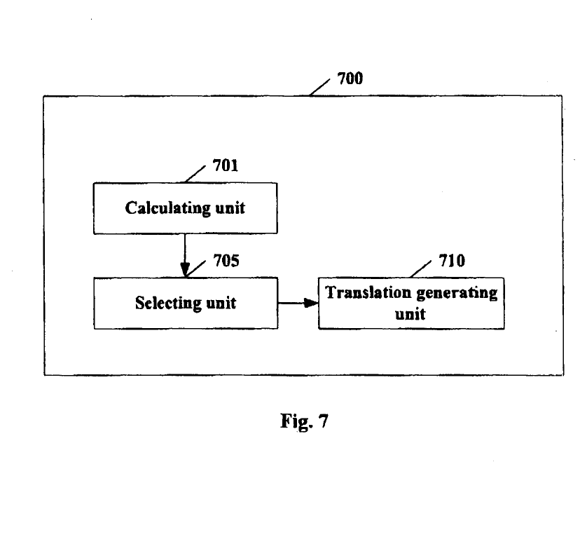

Under the same inventive conception, FIG. 7 is a block diagram showing an apparatus for generating a translation according to another embodiment of the present invention. Next, the present embodiment will be described in conjunction with FIG. 7. For those same parts as the above embodiments, the description of which will be appropriately omitted.

As shown in FIG. 7, an apparatus 700 for generating a translation in this embodiment comprises: a calculating unit 701 configured to calculate an integrated score obtained from a plurality of feature functions on a translation fragment combination; a selecting unit 705 configured to select an optimum translation fragment combination of a second language from a plurality of possible translation fragment combinations of the second language corresponding to a sentence of a first language based on the integrated score obtained from a plurality of feature functions on a translation fragment combination calculated by the calculating unit 701; and a translation generating unit 710 configured to generate the translation of the second language based on the above-mentioned optimum translation fragment combination; wherein the sentence of the first language to be translated is split into a plurality of fragments, an aligned bilingual example corpus comprises a plurality of example sentence pairs of the first language and the second language and alignment information between each sentence pair, and comprises at least one translation fragment of the second language corresponding to each of the above-mentioned plurality of fragments of the first language.

Specifically, in this embodiment, the sentence of the first language to be translated is split into a plurality of fragments by hand or automatically, and one or a plurality of translation fragments of the second language corresponding to each of the plurality of fragments of the first language to be translated are searched in an aligned bilingual example corpus by matching. The aligned bilingual example corpus is a bilingual example corpus word-aligned by a professional (for example, a translator) by hand or by a computer automatically, which comprises a plurality of example sentence pairs of the first language and the second language and alignment information between each sentence pair. It should be understood that, the present invention has no special limitation to the method for splitting a sentence of the first language to be translated, and any method as known in the art can be used, if only a sentence to be translated can be split into effective fragments, translation fragments of which can be found in an aligned bilingual example corpus.

Next, a detailed description of the above-mentioned plurality of feature functions and a calculating process of an integrated score obtained from a plurality of feature functions on a translation fragment combination calculated by the calculating unit 701 will be given.

In this embodiment, the above-mentioned feature functions indicate a plurality of kinds of translation knowledge contained in a translation generating model of a machine translation system based on bilingual example sentences (in the model, translation knowledge is called a feature function), for example, a feature function of calculating similarity between a bilingual example sentence and an inputted sentence, reliability of a bilingual example sentence and fluency of a generated translation.

The feature functions of the embodiment comprise but not limit to the following kinds:

A a translation probability of a word from a source language to a target language

$${h}_{w , f \to e} ( e , f ) = {\prod }_{i} p ( {e}_{{a}_{i}} \vert {f}_{i} )$$

B a translation probability of a word from a target language to a source language

$${h}_{w , e \to f} ( e , f ) = {\prod }_{i} p ( {f}_{{a}_{i}} \vert {e}_{i} )$$

C a translation probability of a phrase from a source language to a target language

$${h}_{ph , f \to e} ( e , f ) = {\prod }_{i} p ( {e}_{{a}_{i}}^{′} \vert {f}_{i}^{′} )$$

D a translation probability of a phrase from a target language to a source language

$${h}_{ph , e \to f} ( e , f ) = {\prod }_{i} p ( {f}_{{a}_{i}}^{′} \vert {e}_{i}^{′} )$$

E a selection probability of a target language based on length

h_{TLS}(e,f,E)=h_{TLS}(e,f)=log p(I|J)

With respect to a sentence to be translated, this function will give a smaller value for a shorter or a longer translation.

F a target language model

$${h}_{TLM} ( e , f , E ) = {h}_{TLM} ( e ) = log {\prod }_{i = 1 … I}^{ } p ( {e}_{i} \vert {e}_{i - 2} , {e}_{i - 1} )$$

The bigger the value of this feature function is, the better the fluency of the translation generated is.

G a semantic similarity

$${h}_{SS} ( e , f , E ) = {h}_{SS} ( f , E ) = log {\prod }_{z ∈ E}^{ } M ( z , f )$$

The bigger the value of this feature function is, the closer the meaning between corresponding fragments in a bilingual example sentence and an inputted sentence is.

In the above-mentioned plurality of feature functions:

h denotes a feature;

f denotes a sentence to be translated;

e denotes a translation generated;

eᵢ denotes a word of a translation;

fᵢ denotes a word of an inputted sentence;

e′ᵢ denotes a phrase of a translation;

fᵢ denotes a phrase of an inputted sentence;

aᵢ denotes a unit number aligning with the i^{th} unit;

I denotes length of e;

J denotes length of f; and

M(z,f) denotes a semantic similarity between corresponding fragments in a bilingual example sentence and an inputted sentence.

Specifically, the feature functions A, B and E are seen in the above-mentioned reference 1.

The feature functions C and D are seen in the above-mentioned reference 2.

The feature function F is seen in the above-mentioned reference 3.

The feature function G is seen in the above-mentioned reference 4.

In this embodiment, the above-mentioned feature functions A-G are shown, however, it should be understood that, the present invention has no special limitation to this, and any feature function contributing to generating a translation can be comprised.

Next, a detailed description of a calculating process of an integrated score obtained from the above-mentioned plurality of feature functions on a translation fragment combination will be given in conjunction with FIG. 2.

FIG. 2 is a sketch map showing an example of calculating an integrated score by the calculating unit 701 according to the embodiment of the present invention. In FIG. 2, first, the sentence of the first language to be translated is split into N fragments, wherein SF[i] denotes the i^{th} fragment of the sentence to be translated. Next, one or a plurality of translation fragments are selected in the aligned bilingual example corpus with respect to each fragment of the sentence to be translated, wherein TF[i,j] denotes the j^{th} translation fragment corresponding to the i^{th} fragment of the sentence to be translated. Next, these selected translation fragments are evaluated respectively by using M feature functions, wherein h[m] denotes the m^{th} feature function on the translation fragment. Then, an integrated score is calculated by using a log-linear model based on the following formula (I):

$$s ( e ) = {\sum }_{m = 1}^{M} {λ}_{m} {h}_{m} ( e , f , E ) \qquad ( 1 )$$

wherein hₘ denotes the m^{th} feature function, λₘ denotes the weight of the m^{th} feature function, f denotes the sentence of the first language to be translated, e denotes the translation fragment combination of the second language, E denotes a collection of translation fragments required to generate e, and s(e) denotes the integrated score obtained from the plurality of feature functions on e.

In this embodiment, the weight of each feature function is taken into account preferably when the integrated score obtained from a plurality of feature functions on a translation fragment combination is calculated by the calculating unit 701, wherein a training method of a weight of a feature function is seen in the above-mentioned reference 5. However, it should be understood that, the above-mentioned integrated score can be calculated directly by integrating scores obtained from each feature function on the translation fragment combination with a log-linear model without taking into account the weight of each feature function.

In this embodiment, a translation fragment combination with a highest score is selected by the selecting unit 705 as an optimum translation fragment combination of the second language with the integrated score obtained from the above-mentioned plurality of feature functions on each of all translation fragment combinations calculated by the calculating unit 701 by using the above-mentioned method shown in FIG. 2.

Optionally, in this embodiment, an optimum translation fragment combination of the second language also can be selected by the selecting unit 705 from a plurality of translation fragment combinations of the second language corresponding to the sentence of the first language by using a searching unit. In this embodiment, the searching unit comprises any unit as known in the art, for example, the searching unit of Beam search algorithm, A search algorithm and A* search algorithm etc, and the present invention has no special limitation to this. A detailed description of a detailed process of a search algorithm will be given in the embodiment of FIG. 4 in conjunction with FIG. 3, wherein the difference with the following embodiment is, in this embodiment, the sentence of the first language to be translated has been split into a plurality of fragments, and not all possible fragments of the sentence to be translated need to be performed with a search algorithm.

Optionally, in this embodiment, the sentence of the first language to be translated can be split in a plurality of splitting schemes, for example, the sentence to be translated is split automatically by a splitting algorithm based on all sentence fragments found. For example:

A sentence to be translated=“w1 w2 w3 w4 w5 w6 w7 w8 w9”

The effective fragments comprise:

F1=w w2 w3

F2=w4 w5 w6

F3=w7 w8 w9

F4=w1 w2 w3 w4

F5=w5 w6 w7 w8 w9

The above fragments can compose two splitting schemes “f1 f2 f3” or “f4 f5”.

For the first splitting scheme “f1 f2 f3”, an optimum translation fragment combination of the second language is selected by using the selecting unit 705, wherein integrated scores obtained from the above-mentioned plurality of feature functions on all translation fragment combinations of the splitting scheme “f1 f2 f3” are calculated by the calculating unit 701 by using the above-mentioned method shown in FIG. 2, and a translation fragment combination with a highest score is selected by using the selecting unit 705 as an optimum translation fragment combination of the second language, or the optimum translation fragment combination of the second language also can be selected by the selecting unit 705 from a plurality of translation fragment combinations of the second language corresponding to the sentence of the first language by using a searching unit.

For the second splitting scheme “f4 f5”, an optimum translation fragment combination of the second language is selected by using the selecting unit 705, wherein integrated scores obtained from the above-mentioned plurality of feature functions on all translation fragment combinations of the splitting scheme “f4 f5” are calculated by the calculating unit 701 by using the above-mentioned method shown in FIG. 2, and a translation fragment combination with a highest score is selected by using the selecting unit 705 as an optimum translation fragment combination of the second language, or the optimum translation fragment combination of the second language also can be selected by the selecting unit 705 from a plurality of translation fragment combinations of the second language corresponding to the sentence of the first language by using a searching unit.

Then, the integrated scores of the optimum translation fragment combination of the two splitting schemes are compared, the translation fragment combination with a high score is kept, and the translation fragment combination with a low score is eliminated, thereby, the optimum translation fragment combination of the second language is obtained for the sentence of the first language to be translated.

Further, the optimum translation fragment combination of the second language also can be selected by the selecting unit 705 from a plurality of translation fragment combinations of the second language corresponding to the sentence of the first language by using a searching unit with respect to the first splitting scheme “f1 f2 f3” and the second splitting scheme “f4 f5”.

It should be understood that, although two splitting schemes are shown herein, the present invention does not limit to this, and it also can have more than two splitting schemes, wherein each splitting scheme merely needs to be calculated, and a plurality of splitting schemes are compared, and the optimum translation fragment combination of the second language is obtained finally.

The apparatus 700 for generating a translation in this embodiment and its each composing part can be composed of a special circuit or CMOS chip, and also can be realized by the computer (processor) executing the relevant program.

By using the apparatus 700 for generating a translation of the embodiment, aligned bilingual example sentences are used as translation knowledge (feature functions namely), and the efficiency of generating a translation is provided effectively relative to the apparatus for generating a translation based on regulations. At the same time, this apparatus can generate a translation with a better quality in a special application.

Further, a translation generated is evaluated with a plurality of kinds of translation knowledge from different points of view by using the apparatus 700 for generating a translation of the embodiment, thus a translation with a high quality is obtained. For example, since translation knowledge used comprises semantic resources and a target language model, the fluency of a translation generated is favorable as well as the semantic similarity thereof with the inputted sentence is very high.

Further, the apparatus 700 for generating a translation of the embodiment can be extended by adding new translation knowledge, thereby the quality of the translation can be further improved.

Apparatus for Generating a Translation

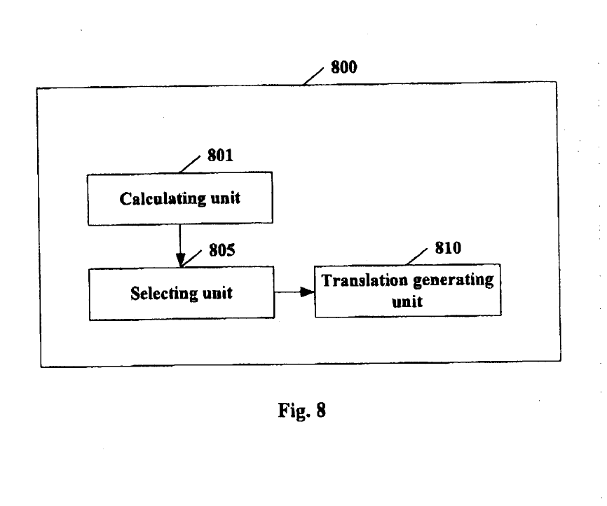

Under the same inventive conception, FIG. 8 is a block diagram showing an apparatus for generating a translation according to another embodiment of the present invention. Next, the present embodiment will be described in conjunction with FIG. 8. For those same parts as the above embodiments, the description of which will be appropriately omitted.

As shown in FIG. 8, an apparatus 800 for generating a translation in this embodiment comprises: a calculating unit 801 configured to calculate an integrated score obtained from a plurality of feature functions on a possible translation fragment or a translation fragment combination; a selecting unit 805 configured to select an optimum translation fragment combination of a second language by using a searching unit, wherein an integrated score is obtained from a plurality of feature functions on a possible translation fragment or a combination of translation fragments by the calculating unit 801 as a cost of a search algorithm; and a translation generating unit 810 configured to generate the translation of the second language based on the above-mentioned optimum translation fragment combination; wherein an aligned bilingual example corpus comprises a plurality of example sentence pairs of a first language and the second language and alignment information between each sentence pair, a sentence of the first language to be translated is matched with respect to the above-mentioned aligned bilingual example corpus, and at least one translation fragment of the second language corresponding to each possible fragment of the above-mentioned sentence of the first language is obtained.

Specifically, in this embodiment, one or a plurality of translation fragments of the second language corresponding to each possible fragment of the first language to be translated are searched in an aligned bilingual example corpus by matching. The aligned bilingual example corpus is a bilingual example corpus word-aligned by a professional (for example, a translator) by hand or by a computer automatically, which comprises a plurality of example sentence pairs of the first language and the second language and alignment information between each sentence pair. It should be understood that, the present invention has no special limitation to the method for matching a sentence of the first language to be translated, and any method as known in the art can be used, if only a corresponding translation fragment can be found for each possible fragment of the sentence to be translated in an aligned bilingual example corpus.

In this embodiment, the searching unit comprises any unit as known in the art, for example, a searching unit performing Beam search algorithm, A search algorithm and A* search algorithm etc, and the present invention has no special limitation to this. A detailed description of a detailed process of a search algorithm will be given in conjunction with FIG. 3. FIG. 3 is a sketch map showing an example of a search algorithm according to the embodiment of the present invention, wherein Beam search algorithm is given as an example to explain the process of a search algorithm briefly, and a detailed description is seen in the above-mentioned reference 6, and the above-mentioned reference 7.

In the embodiment of FIG. 3, the sentence to be translated is hypothesized to have 9 words. A translation of each possible fragment is searched in the aligned bilingual example corpus. For example:

A sentence fragment: There is a red jacket on the bed

A translation fragment:

[symbol]

[symbol]

[symbol]

[symbol]

[symbol]

In FIG. 3, each status comprises:

S: a sign, if a word is translated, the word is signed with “*”, otherwise, if a word is not translated, the word is signed with “-”;

T: a translation of the word with “*”;

Score: an integrated score of the translation obtained.

Specifically, Beam search algorithm is performed as follows:

First, a list (words=0 . . . 9) is initialized;

Next, for s=0 to 9:

Extending each status in S[s]

A new status is stored in a corresponding list based on a status sign. If the amount of words translated in the status is x, the status will be stored in the list of words=x.

If there is a status same with the new status in the list, the two statuses are compared, and the status with a high score is kept.

Pruning the List

If the amount of the statuses in one list is bigger than a predetermined threshold, the statuses with small scores are pruned.

Finally, a translation fragment combination with a highest score is searched in the list S[9] as an optimum translation fragment combination of the second language selected for a sentence of the first language to be translated.

In the above-mentioned search algorithm, the integrated score obtained from a plurality of feature functions on each translation fragment or each fragment combination is calculated by the calculating unit 801 based on the method of the above-mentioned embodiment of FIG. 2, the description of which will be appropriately omitted.

The apparatus 800 for generating a translation in this embodiment and its each composing part can be composed of a special circuit or CMOS chip, and also can be realized by the computer (processor) executing the relevant program.

By using the apparatus 800 for generating a translation of the embodiment, aligned bilingual example sentences are used as translation knowledge (feature functions namely), and the efficiency of generating a translation is provided effectively relative to the apparatus for generating a translation based on regulations. At the same time, this apparatus can generate a translation with a better quality in a special application.

Further, a translation generated is evaluated with a plurality of kinds of translation knowledge from different points of view by using the apparatus 800 for generating a translation of the embodiment, thus a translation with a high quality is obtained. For example, since translation knowledge used comprises semantic resources and a target language model, the fluency of a translation generated is favorable as well as the semantic similarity thereof with the inputted sentence is very high.

Further, the apparatus 800 for generating a translation of the embodiment can be extended by adding new translation knowledge, thereby the quality of the translation can be further improved.

Further, the apparatus 800 for generating a translation of the embodiment does not need to split a sentence of the first language to be translated in advance, and it merely needs to generate a translation with a high quality by using a search algorithm.

Apparatus for Machine Translation

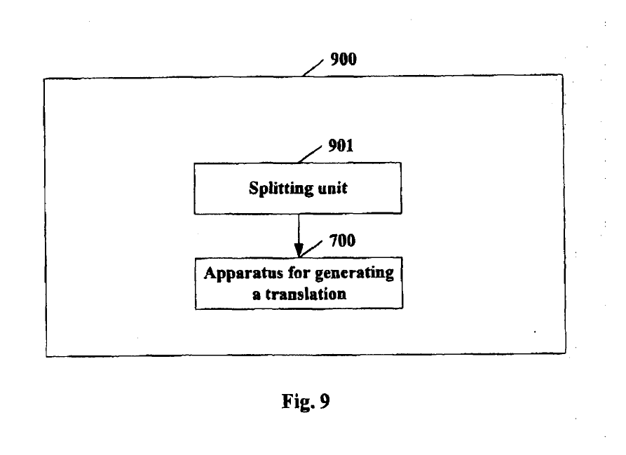

Under the same inventive conception, FIG. 9 is a block diagram showing an apparatus for machine translation according to another embodiment of the present invention. Next, the present embodiment will be described in conjunction with FIG. 9. For those same parts as the above embodiments, the description of which will be appropriately omitted.

As shown in FIG. 9, an apparatus 900 for machine translation in this embodiment comprises: a splitting unit 901 configured to split a sentence of a first language to be translated into a plurality of fragments; and the above-mentioned apparatus 700 for generating a translation configured to generate the translation of a second language; wherein an aligned bilingual example corpus comprises a plurality of example sentence pairs of the first language and the second language and alignment information between each sentence pair.

Specifically, in this embodiment, the sentence of the first language to be translated is split into a plurality of fragments by hand or automatically, and one or a plurality of translation fragments of the second language corresponding to each of the plurality of fragments of the first language to be translated are searched in an aligned bilingual example corpus by matching. The aligned bilingual example corpus is a bilingual example corpus word-aligned by a professional (for example, a translator) by hand or by a computer automatically, which comprises a plurality of example sentence pairs of the first language and the second language and alignment information between each sentence pair. It should be understood that, the present invention has no special limitation to the method for splitting a sentence of the first language to be translated, and any method as known in the art can be used, if only a sentence to be translated can be split into effective fragments, translation fragments of which can be found in an aligned bilingual example corpus.

The apparatus 700 for generating a translation of the embodiment is an apparatus for generating a translation of the above-mentioned embodiment of FIG. 7, and the detailed description is same with the above-mentioned embodiment, which will be omitted herein.

The apparatus 900 for machine translation in this embodiment and its each composing part can be composed of a special circuit or CMOS chip, and also can be realized by the computer (processor) executing the relevant program.

By using the apparatus 900 for machine translation of the embodiment, aligned bilingual example sentences are used as translation knowledge (feature functions namely), and the efficiency of machine translation is provided effectively relative to the apparatus for machine translation based on regulations. At the same time, this apparatus can generate a translation with a better quality in a special application.

Further, a translation generated is evaluated with a plurality of kinds of translation knowledge from different points of view by using the apparatus 900 for machine translation of the embodiment, thus a translation with a high quality is obtained. For example, since translation knowledge used comprises semantic resources and a target language model, the fluency of a translation generated is favorable as well as the semantic similarity thereof with the inputted sentence is very high.

Further, the apparatus 900 for machine translation of the embodiment can be extended by adding new translation knowledge, thereby the quality of the translation can be further improved.

Apparatus for Machine Translation

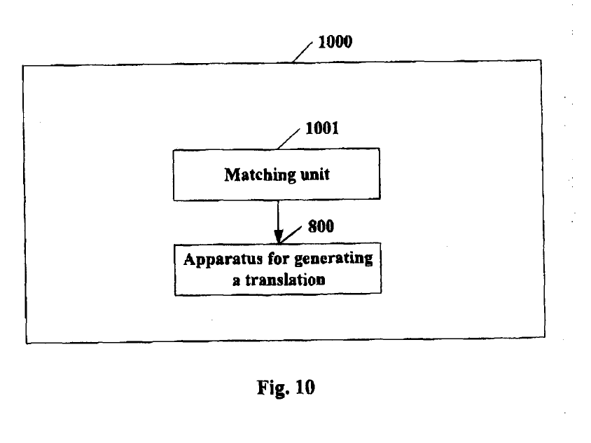

Under the same inventive conception, FIG. 10 is a block diagram showing an apparatus for machine translation according to another embodiment of the present invention. Next, the present embodiment will be described in conjunction with FIG. 10. For those same parts as the above embodiments, the description of which will be appropriately omitted.

As shown in FIG. 10, an apparatus 1000 for machine translation in this embodiment comprises: a matching unit 1001 configured to match a sentence of a first language to be translated with respect to the above-mentioned aligned bilingual example corpus to obtain at least one translation fragment of a second language corresponding to each possible fragment of the above-mentioned sentence of the first language; and the apparatus 800 for generating a translation configured to generate the translation of the second language; wherein an aligned bilingual example corpus comprises a plurality of example sentence pairs of the first language and the second language and alignment information between each sentence pair.

Specifically, in this embodiment, one or a plurality of translation fragments of the second language corresponding to each possible fragment of the first language to be translated are searched in an aligned bilingual example corpus by matching. The aligned bilingual example corpus is a bilingual example corpus word-aligned by a professional (for example, a translator) by hand or by a computer automatically, which comprises a plurality of example sentence pairs of the first language and the second language and alignment information between each sentence pair. It should be understood that, the present invention has no special limitation to the method for matching a sentence of the first language to be translated, and any method as known in the art can be used, if only a corresponding translation fragment can be found for each possible fragment of the sentence to be translated in an aligned bilingual example corpus.

The apparatus 800 for generating a translation of the embodiment is an apparatus for generating a translation of the above-mentioned embodiment of FIG. 8, and the detailed description is same with the above-mentioned embodiment, which will be omitted herein.

The apparatus 1000 for machine translation in this embodiment and its each composing part can be composed of a special circuit or CMOS chip, and also can be realized by the computer (processor) executing the relevant program.

By using the apparatus 1000 for machine translation of the embodiment, aligned bilingual example sentences are used as translation knowledge (feature functions namely), and the efficiency of machine translation is provided effectively relative to the apparatus for machine translation based on regulations. At the same time, this apparatus can generate a translation with a better quality in a special application.

Further, a translation generated is evaluated with a plurality of kinds of translation knowledge from different points of view by using the apparatus 1000 for machine translation of the embodiment, thus a translation with a high quality is obtained. For example, since translation knowledge used comprises semantic resources and a target language model, the fluency of a translation generated is favorable as well as the semantic similarity thereof with the inputted sentence is very high.

Further, the apparatus 1000 for machine translation of the embodiment can be extended by adding new translation knowledge, thereby the quality of the translation can be further improved.

Further, the apparatus 1000 for machine translation of the embodiment does not need to split a sentence of the first language to be translated in advance, and it merely needs to generate a translation with a high quality by using a search algorithm.

Though a method for generating a translation, a method for machine translation, an apparatus for generating a translation, and an apparatus for machine translation have been described in details with some exemplary embodiments, these above embodiments are not exhaustive. Those skilled in the art can make various variations and modifications within the spirit and the scope of the present invention. Therefore, the present invention is not limited to these embodiments; rather, the scope of the present invention is only defined by the appended claims.

What is claimed is:

1. A method for generating a translation, wherein a sentence of a first language to be translated is split into a plurality of fragments, an aligned bilingual example corpus comprises a plurality of example sentence pairs of the first language and a second language and alignment information between each sentence pair, and comprises at least one translation fragment of the second language corresponding to each of said plurality of fragments of the first language; the method comprising:
selecting an optimum translation fragment combination of the second language from a plurality of possible translation fragment combinations of the second language corresponding to said sentence of the first language based on an integrated score obtained from a plurality of feature functions on a translation fragment combination; and
generating the translation of the second language based on said optimum translation fragment combination.

2. The method according to claim 1, wherein said step of selecting comprises:
selecting an optimum translation fragment combination of the second language based on an integrated score obtained from a plurality of feature functions on each of said plurality of possible translation fragment combinations.

3. The method according to claim 1, wherein, said sentence of the first language to be translated is split in a plurality of splitting schemes, and said step of selecting comprises: selecting an optimum translation fragment combination of the second language based on an integrated score obtained from a plurality of feature functions on a translation fragment combination of each of said plurality of splitting schemes.

4. The method according to claim 3, wherein said step of selecting comprises: selecting an optimum translation fragment combination of the second language based on an integrated score obtained from a plurality of feature functions on each of said plurality of translation fragment combinations of each of said plurality of splitting schemes.

5. The method according to any one of claims 1-4, wherein said integrated score obtained from a plurality of feature functions on a translation fragment combination is calculated by integrating scores obtained from each of said plurality of feature functions on said translation fragment combination with a log-linear model.

6. The method according to claim 5, wherein said step of calculating said integrated score obtained from a plurality of feature functions on a translation fragment combination further takes into account a weight of each of said plurality of feature functions.

7. The method according to claim 6, wherein said step of calculating said integrated score obtained from a plurality of feature functions on a translation fragment combination is performed with the following formula:
$$s ( e ) = {\sum }_{m = 1}^{M} {λ}_{m} {h}_{m} ( e , f , E )$$
wherein hₘ denotes the m^{th} feature function, λₘ denotes the weight of the m^{th} feature function, f denotes said sentence of the first language to be translated, e denotes said translation fragment combination of the second language, E denotes a collection of translation fragments required to generate e, and s(e) denotes said integrated score obtained from said plurality of feature functions on e.

8. The method according to claim 1 or 3, wherein said step of selecting comprises: selecting an optimum translation fragment combination of the second language by using a search algorithm, wherein an integrated score is obtained from said plurality of feature functions on a possible translation fragment or a combination of translation fragments as a cost of said search algorithm.

9. The method according to claim 1, wherein said sentence of the first language to be translated is split in a plurality of splitting schemes, and said step of selecting comprises: selecting an optimum translation fragment combination of the second language by using a search algorithm, wherein an integrated score is obtained from said plurality of feature functions on a possible translation fragment or a combination of translation fragments as a cost of said search algorithm.

10. The method according to claim 8, wherein said integrated score obtained from said plurality of feature functions on a possible translation fragment or a combination of translation fragments is calculated by integrating scores obtained from each of said plurality of feature functions on said possible translation fragment or said combination of translation fragments with a log-linear model.

11. The method according to claim 10, wherein said step of calculating said integrated score obtained from said plurality of feature functions on a possible translation fragment or a combination of translation fragments further takes into account a weight of each of said plurality of feature functions.

12. The method according to claim 11, wherein said step of calculating said integrated score obtained from said plurality of feature functions on a possible translation fragment or a combination of translation fragments is performed with the following formula:
$$s ( e ) = {\sum }_{m = 1}^{M} {λ}_{m} {h}_{m} ( e , f , E )$$
wherein hₘ denotes the m^{th} feature function, ?ₘ denotes the weight of the m^{th} feature function, f denotes said possible fragment or said combination of fragments of the first language, e denotes said possible translation fragment or said combination of translation fragments of the second language, E denotes a collection of translation fragments required to generate e, and s(e) denotes said integrated score obtained from said plurality of feature functions on e.

13. The method according to claim 7 or 12, wherein said plurality of feature functions comprise: any functions selected from a translation probability of a word from a source language to a target language, a translation probability of a word from a target language to a source language, a translation probability of a phrase from a source language to a target language, a translation probability of a phrase from a target language to a source language, a selection probability of a target language based on length, a target language model, and a semantic similarity.

14. A method for generating a translation, wherein an aligned bilingual example corpus comprises a plurality of example sentence pairs of a first language and a second language and alignment information between each sentence pair, a sentence of the first language to be translated is matched with respect to said aligned bilingual example corpus, and at least one translation fragment of the second language corresponding to each possible fragment of said sentence of the first language is obtained; the method comprising:
selecting an optimum translation fragment combination of the second language by using a search algorithm, wherein an integrated score is obtained from a plurality of feature functions on a possible translation fragment or a combination of translation fragments as a cost of said search algorithm; and
generating the translation of the second language based on said optimum translation fragment combination.

15. The method according to claim 14, wherein said integrated score obtained from said plurality of feature functions on a possible translation fragment or a combination of translation fragments is calculated by integrating scores obtained from each of said plurality of feature functions on said possible translation fragment or said combination of translation fragments with a log-linear model.

16. The method according to claim 15, wherein said step of calculating said integrated score obtained from said plurality of feature functions on a possible translation fragment or a combination of translation fragments further takes into account a weight of each of said plurality of feature functions.

17. The method according to claim 16, wherein said step of calculating said integrated score obtained from said plurality of feature functions on a possible translation fragment or a combination of translation fragments is performed with the following formula:
$$s ( e ) = {\sum }_{m = 1}^{M} {λ}_{m} {h}_{m} ( e , f , E )$$
wherein hₘ denotes the m^{th} feature function, ?ₘ denotes the weight of the m^{th} feature function, f denotes said possible fragment or said combination of fragments of the first language, e denotes said possible translation fragment or said combination of translation fragments of the second language, E denotes a collection of translation fragments required to generate e, and s(e) denotes said integrated score obtained from said plurality of feature functions on e.

18. The method according to claim 17, wherein said plurality of feature functions comprise: any functions selected from a translation probability of a word from a source language to a target language, a translation probability of a word from a target language to a source language, a translation probability of a phrase from a source language to a target language, a translation probability of a phrase from a target language to a source language, a selection probability of a target language based on length, a target language model, and a semantic similarity.

19. A method for machine translation, wherein an aligned bilingual example corpus comprises a plurality of example sentence pairs of a first language and a second language and alignment information between each sentence pair; the method comprising:
splitting a sentence of the first language to be translated into a plurality of fragments; and
generating the translation of the second language by means of the method for generating a translation according to any one of claims 1-13.

20. A method for machine translation, wherein an aligned bilingual example corpus comprises a plurality of example sentence pairs of a first language and a second language and alignment information between each sentence pair; the method comprising:
matching a sentence of the first language to be translated with respect to said aligned bilingual example corpus to obtain at least one translation fragment of the second language corresponding to each possible fragment of said sentence of the first language; and
generating the translation of the second language by means of the method for generating a translation according to any one of claims 14-18.

21. An apparatus for generating a translation, wherein a sentence of a first language to be translated is split into a plurality of fragments, an aligned bilingual example corpus comprises a plurality of example sentence pairs of the first language and a second language and alignment information between each sentence pair, and comprises at least one translation fragment of the second language corresponding to each of said plurality of fragments of the first language; the apparatus comprising:
a selecting unit configured to select an optimum translation fragment combination of the second language from a plurality of possible translation fragment combinations of the second language corresponding to said sentence of the first language based on an integrated score obtained from a plurality of feature functions on a translation fragment combination; and
a translation generating unit configured to generate the translation of the second language based on said optimum translation fragment combination.

22. The apparatus according to claim 21, wherein said selecting unit is configured to select an optimum translation fragment combination of the second language based on an integrated score obtained from a plurality of feature functions on each of said plurality of possible translation fragment combinations.

23. The apparatus according to claim 21, wherein said sentence of the first language to be translated is split in a plurality of splitting schemes, and said selecting unit is configured to select an optimum translation fragment combination of the second language based on an integrated score obtained from a plurality of feature functions on a translation fragment combination of each of said plurality of splitting schemes.

24. The apparatus according to claim 23, wherein said selecting unit is configured to select an optimum translation fragment combination of the second language based on an integrated score obtained from a plurality of feature functions on each of said plurality of translation fragment combinations of each of said plurality of splitting schemes.

25. The apparatus according to any one of claims 21-24, further comprising a calculating unit configured to calculate said integrated score obtained from a plurality of feature functions on a translation fragment combination by integrating scores obtained from each of said plurality of feature functions on said translation fragment combination with a log-linear model.

26. The apparatus according to claim 25, wherein said calculating unit further takes into account a weight of each of said plurality of feature functions during calculating said integrated score obtained from a plurality of feature functions on a translation fragment combination.

27. The apparatus according to claim 26, wherein said calculating unit calculates said integrated score obtained from a plurality of feature functions on a translation fragment combination with the following formula:
$$s ( e ) = {\sum }_{m = 1}^{M} {λ}_{m} {h}_{m} ( e , f , E )$$
wherein hₘ denotes the m^{th} feature function, ?ₘ denotes the weight of the m^{th} feature function, f denotes said sentence of the first language to be translated, e denotes said translation fragment combination of the second language, E denotes a collection of translation fragments required to generate e, and s(e) denotes said integrated score obtained from said plurality of feature functions on e.

28. The apparatus according to claim 21 or 23, wherein said selecting unit is configured to select an optimum translation fragment combination of the second language by using a search algorithm, wherein an integrated score is obtained from said plurality of feature functions on a possible translation fragment or a combination of translation fragments as a cost of said search algorithm.

29. The apparatus according to claim 21, wherein said sentence of the first language to be translated is split in a plurality of splitting schemes, and said selecting unit is configured to select an optimum translation fragment combination of the second language by using a search algorithm, wherein an integrated score is obtained from said plurality of feature functions on a possible translation fragment or a combination of translation fragments as a cost of said search algorithm.

30. The apparatus according to claim 28, further comprising a calculating unit configured to calculate said integrated score obtained from said plurality of feature functions on a possible translation fragment or a combination of translation fragments by integrating scores obtained from each of said plurality of feature functions on said possible translation fragment or said combination of translation fragments with a log-linear model.

31. The apparatus according to claim 30, wherein said calculating unit further takes into account a weight of each of said plurality of feature functions during calculating said integrated score obtained from said plurality of feature functions on a possible translation fragment or a combination of translation fragments.

32. The apparatus according to claim 31, wherein said calculating unit is configured to calculate said integrated score obtained from said plurality of feature functions on a possible translation fragment or a combination of translation fragments with the following formula:
$$s ( e ) = {\sum }_{m = 1}^{M} {λ}_{m} {h}_{m} ( e , f , E )$$
wherein hₘ denotes the m^{th} feature function, ?ₘ denotes the weight of the m^{th} feature function, f denotes said possible fragment or said combination of fragments of the first language, e denotes said possible translation fragment or said combination of translation fragments of the second language, E denotes a collection of translation fragments required to generate e, and s(e) denotes said integrated score obtained from said plurality of feature functions on e.

33. The apparatus according to claim 27 or 32, wherein said plurality of feature functions comprise: any functions selected from a translation probability of a word from a source language to a target language, a translation probability of a word from a target language to a source language, a translation probability of a phrase from a source language to a target language, a translation probability of a phrase from a target language to a source language, a selection probability of a target language based on length, a target language model, and a semantic similarity.

34. An apparatus for generating a translation, wherein an aligned bilingual example corpus comprises a plurality of example sentence pairs of a first language and a second language and alignment information between each sentence pair, a sentence of the first language to be translated is matched with respect to said aligned bilingual example corpus, and at least one translation fragment of the second language corresponding to each possible fragment of said sentence of the first language is obtained; the apparatus comprising:
a selecting unit configured to select an optimum translation fragment combination of the second language by using a search algorithm, wherein an integrated score is obtained from a plurality of feature functions on a possible translation fragment or a combination of translation fragments as a cost of said search algorithm; and
a translation generating unit configured to generate the translation of the second language based on said optimum translation fragment combination.

35. The apparatus according to claim 34, further comprising a calculating unit configured to calculate said integrated score obtained from said plurality of feature functions on a possible translation fragment or a combination of translation fragments by integrating scores obtained from each of said plurality of feature functions on said possible translation fragment or said combination of translation fragments with a log-linear model.

36. The apparatus according to claim 35, wherein said calculating unit further takes into account a weight of each of said plurality of feature functions during calculating said integrated score obtained from said plurality of feature functions on a possible translation fragment or a combination of translation fragments.

37. The apparatus according to claim 36, wherein said calculating unit is configured to calculate said integrated score obtained from said plurality of feature functions on a possible translation fragment or a combination of translation fragments with the following formula:
$$s ( e ) = {\sum }_{m = 1}^{M} {λ}_{m} {h}_{m} ( e , f , E )$$
wherein hₘ denotes the m^{th} feature function, ?m denotes the weight of the m^{th} feature function, f denotes said possible fragment or said combination of fragments of the first language, e denotes said possible translation fragment or said combination of translation fragments of the second language, E denotes a collection of translation fragments required to generate e, and s(e) denotes said integrated score obtained from said plurality of feature functions on e.

38. The apparatus according to claim 37, wherein said plurality of feature functions comprise: any functions selected from a translation probability of a word from a source language to a target language, a translation probability of a word from a target language to a source language, a translation probability of a phrase from a source language to a target language, a translation probability of a phrase from a target language to a source language, a selection probability of a target language based on length, a target language model, and a semantic similarity.

39. An apparatus for machine translation, wherein an aligned bilingual example corpus comprises a plurality of example sentence pairs of a first language and a second language and alignment information between each sentence pair; the apparatus comprising:
a splitting unit configured to split a sentence of the first language to be translated into a plurality of fragments; and
the apparatus for generating a translation according to any one of claims 21-33 configured to generate the translation of the second language.

40. An apparatus for machine translation, wherein an aligned bilingual example corpus comprises a plurality of example sentence pairs of a first language and a second language and alignment information between each sentence pair; the apparatus comprising:
a matching unit configured to match a sentence of the first language to be translated with respect to said aligned bilingual example corpus to obtain at least one translation fragment of the second language corresponding to each possible fragment of said sentence of the first language; and
the apparatus for generating a translation according to any one of claims 34-38 configured to generate the translation of the second language.
